(19) United States
(12) Patent Application Publication
(10) Pub. No.: US 2024/0244592 A1
(43) Pub. Date: Jul. 18, 2024

(54) TERMINAL AND RADIO COMMUNICATION METHOD

(71) Applicant: NTT DOCOMO, INC., Tokyo (JP)

(72) Inventors: Haruhi Echigo, Tokyo (JP); Daisuke Kurita, Tokyo (JP); Hiroki Harada, Tokyo (JP)

(73) Assignee: NTT DOCOMO, INC., Tokyo (JP)

(21) Appl. No.: 18/562,188

(22) PCT Filed: Mar. 30, 2022
(86) PCT No.: PCT/JP2022/015833

§ 371 Date: Nov. 17, 2023

(30) Foreign Application Priority Data
May 21, 2021 (JP) 2021-086479

(51) Int. Cl. H04W 72/04; H04W 72/1268

(52) U.S. Cl. CPC H04W 72/04; H04W 72/1268

(57) ABSTRACT

A terminal allocates a physical uplink shared channel across multiple slots and transmits the data series via the physical uplink shared channel. The terminal performs rate matching for each data series transmitted in a specific time region.

### TECHNICAL FIELD

The present disclosure relates to a terminal and a radio communication method supporting coverage extension.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

For example, in 3GPP Release-17, it was agreed to consider coverage enhancement (CE) in NR (Non-Patent Literature 1).

With respect to coverage extension, it has also been agreed (Non-Patent Literature 2) to consider a method for determining the time resources of a physical uplink shared channel allocated to multiple slots, specifically TB processing over multi-slot PUSCH (TBOMS) that processes transport blocks (TBs) through a Physical Uplink Shared Channel (PUSCH).

### CITATION LIST

### Non-Patent Literature

### [Non-Patent Literature 1]

“New WID on NR coverage enhancements,” RP-202928, 3GPP TSG RAN meeting #90e, 3GPP, December 2020

### [Non-Patent Literature 2]

“RAN1 Chairman's Notes,” 3GPP TSG RAN WG1 Meeting #104e e-Meeting, 3GPP, February 2021

### SUMMARY OF INVENTION

However, in 3GPP Releases-15 and 16, the transport block size (TBS) is specified on the basis of a single slot, and even if the TBS is applied to the TBoMS as it is, it may not always be efficient.

Accordingly, the following disclosure is made in view of this situation, and it is an object of the present invention to provide a terminal and a radio communication method capable of more efficiently realizing a TBOMS for processing a transport block (TB) via a physical uplink shared channel (PUSCH) allocated to a plurality of slots.

An aspect of the present disclosure is a terminal (UE200) including a reception unit (control signal and reference signal processing unit 240) for receiving control information indicating allocation of a physical uplink shared channel in a time region, and a control unit (control unit 270) for allocating the physical uplink shared channel across multiple slots, wherein the control unit determines a transport block transmitted via the physical uplink shared channel based on the control information.

An aspect of the present disclosure is a terminal (UE200) including a control unit (control unit 270) for allocating a physical uplink shared channel across multiple slots, and a transmission unit (radio signal transmission and reception unit 210) for transmitting a data series via the physical uplink shared channel, wherein the transmission unit repeatedly transmits the data series after the plurality of code blocks are concatenated via the physical uplink shared channel.

An aspect of the present disclosure is a terminal (UE200) including a control unit (control unit 270) for allocating a physical uplink shared channel across multiple slots, and a transmission unit (radio signal transmission and reception unit 210) for transmitting the physical uplink shared channel, wherein the control unit determines the size of a transport block transmitted via the physical uplink shared channel based on configuration information of the physical uplink shared channel in a serving cell.

An aspect of the present disclosure is a terminal (UE200) including a control unit (control unit 270) for allocating a physical uplink shared channel across multiple slots, and a transmission unit (radio signal transmission and reception unit 210) for transmitting the physical uplink shared channel, wherein the control unit is determines the division of a transport block transmitted via the physical uplink shared channel into a plurality of code blocks based on whether the physical uplink shared channel is allocated across the multiple slots.

An aspect of the present disclosure is a terminal (UE200) including a control unit (control unit 270) for allocating a physical uplink shared channel across multiple slots and a transmission unit (radio signal transmission and reception unit 210) for transmitting the physical uplink shared channel, wherein the control unit determines a modulation and encoding scheme applied to the physical uplink shared channel based on whether the physical uplink shared channel is allocated across the multiple slots.

An aspect of the present disclosure is a terminal (UE200) including a control unit (control unit 270) for allocating a physical uplink shared channel across multiple slots and a transmission unit (radio signal transmission and reception unit 210) for transmitting data series via the physical uplink shared channel, wherein the control unit performs rate matching for each data series transmitted in a specific time region.

An aspect of the present disclosure is a radio communication method including the steps of receiving control information indicating allocation of a physical uplink shared channel in the time region and allocating the physical uplink shared channel across the multiple slots, wherein in the step of allocating the physical uplink shared channel, a transport block transmitted via the physical uplink shared channel is determined based on the control information.

An aspect of the present disclosure is a radio communication method including the steps of allocating a physical uplink shared channel across multiple slots and transmitting data series via the physical uplink shared channel, wherein in the step of allocating, rate matching is performed for each data series transmitted in a specific time region.

### BRIEF DESCRIPTION OF DRAWINGS

FIG. 1 is an overall schematic diagram of a radio communication system 10.

FIG. 2 is a diagram showing a configuration example of a radio frame, a sub-frame and a slot used in the radio communication system 10.

FIG. 3 is a functional block configuration diagram of a gNB100 and a UE200.

FIG. 4 is a diagram showing an example of allocation of PUSCH by TBOMS.

FIG. 5 is an explanatory diagram of problems in an example of allocation of PUSCH by TBOMS (Type A repetition like TDRA).

FIG. 6 is a diagram showing an example of allocation of the PUSCH time domain according to operation example 1 (Opt 1, 2).

FIG. 7 is a diagram showing an example of allocation of the PUSCH (TB) according to operation example 2 (Alt 1-1-1).

FIG. 8 is a diagram showing an example of configuration of the redundancy version (RV) according to operation example 2 (Alt 2-2).

FIG. 9 is a diagram showing an example of calculation of Nshsymb according to operation example 3-1 (Opt 1).

FIG. 10 is a diagram showing an example of allocation of TB according to operation example 4 (Alt 2).

FIG. 11 is a diagram showing an example of allocation of TB according to operation example 4 (Alt 4-1).

FIG. 12 is a diagram showing an example of Repetition of the UL channel according to operation example 6 (Opt 3).

FIG. 13 is a diagram showing an example of Repetition of the UL channel according to operation example 6-1 (Opt 4).

FIG. 14 is a diagram showing an example of Repetition of the UL channel according to operation example 6-2 (Opt 3, 4).

FIG. 15 is a diagram showing an example of Repetition of the UL channel according to operation example 6-2 (Opt 5).

FIG. 16 is a diagram showing an example of Repetition of the UL channel according to operation example 6-3 (Alt 1, 2).

FIG. 17 is a diagram showing an example of Repetition of the UL channel according to operation example 6-3 (Alt 3, 4).

FIG. 18 is a diagram showing a configuration example of the MAC RAR according to operation example 7.

FIG. 19 is a diagram showing a configuration example of slot allocation and redundancy version (RV) according to operation example 8.

FIG. 20 is a diagram showing an example of a hardware configuration of gNB100 and UE200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

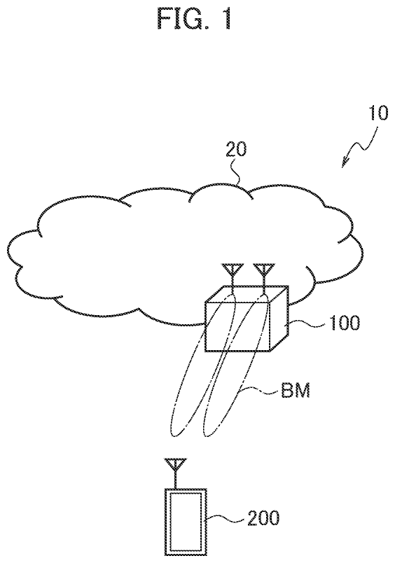

FIG. 1 is an overall schematic configuration diagram of the radio communication system 10 according to the present embodiment. The radio communication system 10 is a radio communication system according to 5G New Radio (NR) and includes the Next Generation-Radio Access Network 20 (hereinafter referred to as the NG-RAN20 and a terminal 200 (User Equipment 200, UE200).

The radio communication system 10 may be a radio communication system according to a system called Beyond 5G, 5G Evolution or 6G.

The NG-RAN20 includes a radio base station 100 (gNB100). The specific configuration of the radio communication system 10 including the number of gNBs and UEs is not limited to the example shown in FIG. 1.

The NG-RAN20 actually includes a plurality of NG-RAN Nodes, specifically gNBs (or ng-eNBs), connected to a core network (5GC, not shown) according to 5G. Note that the NG-RAN20 and 5 GCs may be referred to simply as “network”.

The gNB100 is a radio base station in accordance with the NR, and performs radio communication in accordance with the UE200 and the NR. The gNB100 and the UE200 can support Massive MIMO, which generates a more directional beam by controlling radio signals transmitted from a plurality of antenna elements, carrier aggregation (CA), which uses a plurality of component carriers (CCs) bundled together, and dual connectivity (DC), which simultaneously communicates between the UE and each of a plurality of NG-RAN nodes.

The radio communication system 10 corresponds to FR1 and FR2. The frequency bands of each FR (Frequency Range) are as follows.
FR1: 410 MHz˜7.125 GHZ
FR2: 24.25 GHz˜52.6 GHZ

FR1 uses sub-carrier spacing (SCS) of 15, 30 or 60 kHz and may use a bandwidth (BW) of 5˜100 MHz. FR2 is higher frequency than FR1 and may use SCS of 60 or 120 kHz (may include 240 kHz) and may use a bandwidth (BW) of 50˜400 MHZ.

In addition, the radio communication system 10 may support higher frequency bands than those of FR2. Specifically, the radio communication system 10 may support frequency bands greater than 52.6 GHZ and up to 114.25 GHZ.

Cyclic Prefix-Orthogonal Frequency Division Multiplexing (CP-OFDM)/Discrete Fourier Transform-Spread (DFT-S-OFDM) with greater Sub-Carrier Spacing (SCS) may also be applied. Furthermore, DFT-S-OFDM may be applied not only to the uplink (UL) but also to the downlink (DL).

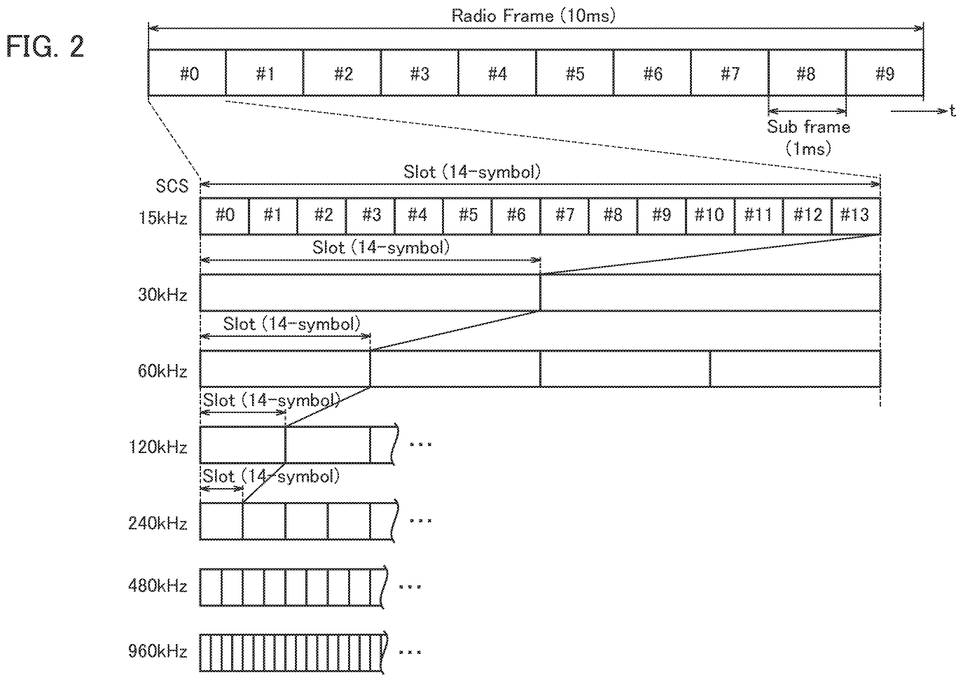

FIG. 2 shows a configuration example of a radio frame, subframe and slot used in the radio communication system 10.

As shown in FIG. 2, one slot is composed of 14 symbols, and the larger (wider) the SCS, the shorter the symbol period (and slot period). Note that the number of symbols constituting one slot may not necessarily be 14 symbols (For example, 28, 56 symbols). The number of slots per subframe may vary depending on the SCS. In addition, the SCS may be wider than 240 kHz (For example, as shown in FIG. 2, 480 kHz, 960 kHz).

Note that the time direction (t) shown in FIG. 2 may be called a time region, a time domain, a symbol period or a symbol time. The frequency direction may be called a frequency region, a frequency domain, a resource block, a resource block group, a subcarrier, a band width part (BWP), a subchannel, a common frequency resource or the like.

The radio communication system 10 can support a Coverage Enhancement (CE) that increases the coverage of the cells (or physical channels) formed by the gNB100. The Coverage Enhancement may provide a mechanism to increase the reception success rate of the various physical channels.

For example, the gNB100 can support the repeated transmission of PDSCH (Physical Downlink Shared Channel) and UE200 can support the repeated transmission of PUSCH (Physical Uplink Shared Channel).

In the radio communication system 10, a time division duplex (TDD) slot configuration pattern may be configured. For example, DDDSU (D: Downlink (DL) symbol, S: DL/Uplink (UL) or Guard symbol, U: UL symbol) may be specified (see 3GPP TS38.101-4).

“D” indicates a slot that contains all DL symbols, and “S” indicates a slot that contains a mixture of DL, UL, and guard symbols (G). “U” indicates a slot that contains all UL symbols. For example, when the S slot is 10D+2G+2U, 2 symbols (2U) and 1 slot (14 symbols) that are continuous in the time direction can be used for UL, that is, a plurality of consecutive slots can be used for UL.

Further, in the radio communication system 10, channel estimation of PUSCH (or PUCCH (Physical Uplink Control Channel)) can be performed by using a demodulation reference signal (DMRS) for each slot, and channel estimation of PUSCH (or PUCCH) can be performed by using a DMRS assigned to each of the plurality of slots. Such channel estimation may be called joint channel estimation. Alternatively, it may be called something else, such as cross-slot channel estimation.

The UE200 can transmit DMRS assigned to multiple slots so that the gNB100 can perform joint channel estimation using DMRS.

The radio communication system 10 may also apply TB processing over multi-slot PUSCH (TBOMS) to process transport blocks (TBs) via PUSCH assigned to multiple slots for coverage extension.

In TBoMS, the number of assigned symbols may be the same in each slot, such as Time Domain Resource Allocation (TDRA) for PUSCH's Repetition type A (described below in detail), or the number of assigned symbols may be different in each slot, such as TDRA for PUSCH's Repetition type B (described below in detail).

TDRA may be interpreted as resource allocation in PUSCH's time domain as specified in 3GPP TS38.214. PUSCH'S TDRA may be interpreted as specified by the Information Element (IE) of the Radio Resource Control Layer (RRC), specifically PDSCH-Config or PDSCH-ConfigCommon.

The TDRA may also be interpreted as a resource allocation in PUSCH's time domain specified by Downlink Control Information (DCI).

### (2) Function Block Configuration of Radio Communication System

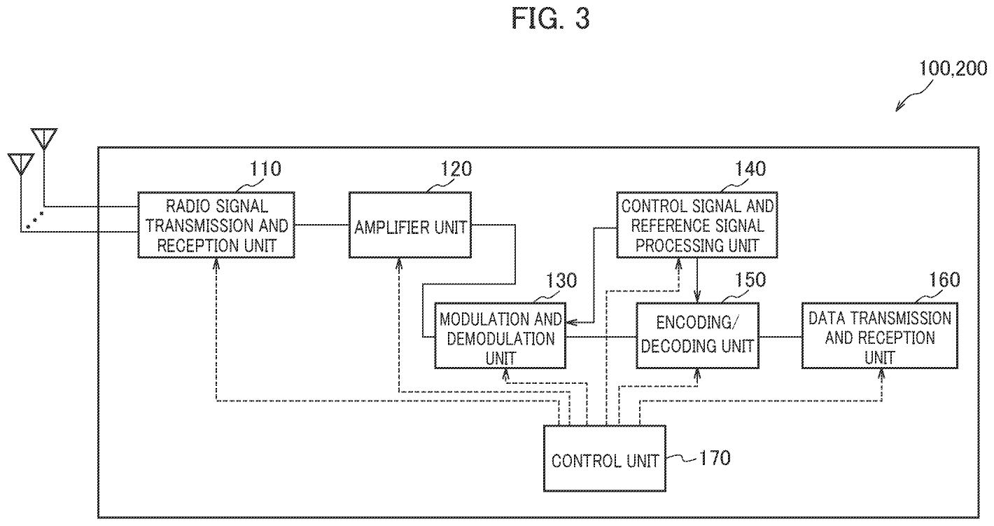

Next, the function block configuration of the radio communication system 10 will be described. Specifically, the function block configuration of the UE200 will be described. FIG. 3 is a function block configuration diagram of the gNB100 and the UE200.

As shown in FIG. 3, the UE200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

Note that in FIG. 3, only the main functional blocks related to the description of the embodiment are shown, and the UE200 (gNB100) has other functional blocks (For example, the power supply unit). FIG. 3 also shows the functional block configuration of the UE200, and refer to FIG. 19 for the hardware configuration.

The radio signal transmission and reception unit 210 transmits and receives radio signals in accordance with the NR. By controlling radio (RF) signals transmitted from a plurality of antenna elements, the radio signal transmission and reception unit 210 can cope with Massive MIMO that generates a beam with higher directivity, carrier aggregation (CA) that uses a plurality of component carriers (CCs) bundled together, and dual connectivity (DC) that simultaneously communicates between a UE and each of two NG-RAN nodes.

The radio signal transmission and reception unit 210 may also transmit a physical uplink shared channel. In this embodiment, the radio signal transmission and reception unit 210 may comprise a transmission unit.

Specifically, the radio signal transmission and reception unit 210 may transmit the PUSCH to the network (gNB100). The radio signal transmission and reception unit 210 may support repetition of the PUSCH.

Multiple types of repeated PUSCH transmissions may be specified. Specifically, Repetition type A and Repetition type B may be specified. Repetition type A may be interpreted as a form in which the PUSCH allocated in the slot is repeatedly transmitted. That is, the PUSCH is 14 symbols or less, and there is no possibility that it is allocated across multiple slots (adjacent slots).

On the other hand, Repetition type B may be interpreted as a repeated transmission of a PUSCH for which more than 15 symbols may be allocated. In this embodiment, it may be acceptable to allocate such a PUSCH across multiple slots.

In addition, the radio signal transmission and reception unit 210 may repeatedly transmit an uplink channel (UL channel) during a specified period of multiple slots or more. The uplink channel may include a physical uplink shared channel (PUSCH) and a physical uplink control channel (PUCCH).

The shared channel may be referred to as a data channel.

A specific period of more than one slot may be interpreted as a period for the repetition of PUSCH (or PUCCH). For example, a specific period may be indicated by the number of repetitions, or it may be the time at which a specified number of repetitions are performed.

Alternatively, the radio signal transmission and reception unit 210 may repeatedly transmit the UL channel a specific number of times. Specifically, the radio signal transmission and reception unit 210 may repeatedly transmit the PUSCH (or PUCCH) a plurality of times.

The specified period and/or the specified number of times may be indicated by signaling from the network (may be a higher layer of RRC or a lower layer such as DCI, hereinafter the same) or may be preset in the UE200.

Further, the radio signal transmission and reception unit 210 may repeatedly transmit the data series after concatenation of the plurality of code blocks (CBs) via the PUSCH. The data series may be replaced with other synonymous terms such as data block, bit series, and bit string. The CB may be a CB after cyclic redundancy checksum (CRC) processing, CB partitioning, channel encoding, and rate matching.

The amplifier unit 220 may be configured with a PA (Power Amplifier)/LNA (Low Noise Amplifier), etc. the amplifier unit 220 amplifies the signal output from the modulation and demodulation unit 230 to a predetermined power level. The amplifier unit 220 amplifies the RF signal output from the radio signal transmission and reception unit 210.

The modulation and demodulation unit 230 performs data modulation/demodulation, transmission power setting, resource block allocation, etc. for each predetermined communication destination (gNB100, etc.). In the modulation and demodulation unit 230, Cyclic Prefix-Orthogonal Frequency Division Multiplexing (CP-OFDM)/Discrete Fourier Transform-Spread (DFT-S-OFDM) may be applied. DFT-S-OFDM may be used not only for uplink (UL) but also for downlink (DL).

The control signal and reference signal processing unit 240 performs processing related to various control signals transmitted and received by the UE200 and various reference signals transmitted and received by the UE200.

Specifically, the control signal and reference signal processing unit 240 receives various control signals transmitted from the gNB100 via a predetermined control channel, for example, a radio resource control layer (RRC) control signal. The control signal and reference signal processing unit 240 also transmits various control signals to the gNB100 via a predetermined control channel.

The control signal and reference signal processing unit 240 executes processing using a reference signal (RS) such as a demodulation reference signal (DMRS) and a phase tracking reference signal (PTRS).

The DMRS is a reference signal (pilot signal) known between a base station and a terminal for each terminal to estimate a fading channel used for data demodulation. The PTRS is a reference signal for each terminal to estimate phase noise, which is a problem in a high frequency band.

In addition to the DMRS and the PTRS, the reference signal may include a Channel State Information-Reference Signal (CSI-RS), a Sounding Reference Signal (SRS), and a Positioning Reference Signal (PRS) for position information.

The channel may include a control channel and a data channel. The control channel may include PDCCH (Physical Downlink Control Channel), PUCCH (Physical Uplink Control Channel), RACH (Random Access Channel, Downlink Control Information (DCI) with Random Access Radio Network Temporary Identifier (RA-RNTI)), and Physical Broadcast. Channel (PBCH).

The data channel includes PDSCH (Physical Downlink Shared Channel) and PUSCH (Physical Uplink Shared Channel). Data may mean data transmitted over a data channel.

The control signal and reference signal processing unit 240 may also transmit UE200's capability information about physical uplink shared channel (PUSCH) assignments to the network. In this embodiment, the control signal and reference signal processing unit 240 may comprise a transmission unit for transmitting capability information.

Specifically, the control signal and reference signal processing unit 240 may transmit UE Capability Information regarding PUSCH assignment (which may include Repetition) to gNB100. Note that UE Capability Information will be described in detail later.

The control signal and reference signal processing unit 240 can also receive control information indicating the allocation in the time domain of PUSCH. In this embodiment, the control signal and reference signal processing unit 240 may comprise reception unit.

Specifically, the control signal and reference signal processing unit 240 may receive downlink control information (DCI) indicating the allocation in the time domain of the PUSCH.

The encoding/decoding unit 250 performs data partitioning/concatenation and channel coding/decoding for each predetermined communication destination (gNB100 or other gNB).

Specifically, the encoding/decoding unit 250 divides the data output from the data transmission and reception unit 260 into predetermined sizes and performs channel coding for the divided data. The encoding/decoding unit 250 decodes the data output from the modulation and demodulation unit 230 and concatenates the decoded data.

The data transmission and reception unit 260 transmits and receives the protocol data unit (PDU) and the service data unit (SDU). Specifically, the data transmission and reception unit 260 performs assembly/disassembly of PDUs/SDUs in a plurality of layers (Media access control layer (MAC), radio link control layer (RLC), packet data convergence protocol layer (PDCP), etc.). The data transmission and reception unit 260 also performs data error correction and retransmission control based on a hybrid automatic repeat request (ARQ).

The control unit 270 controls each function block constituting the UE200. In particular, in this embodiment, the control unit 270 controls the transmission of the UL channel, specifically, the PUSCH and the PUCCH.

Specifically, the control unit 270 can hop the UL channel in the frequency direction for a specific period of more than one slot. The hopping in the frequency direction of the UL channel may be called frequency hopping, and the frequency hopping in a specific period of more than one slot may be called inter-slot frequency hopping. The hopping may mean that the frequency resources to be used change. In short, it may mean that the subcarriers, resource blocks, resource block groups or BWPs change.

The control unit 270 may also cause the UL channel to hop in the frequency direction in units of a specific number of times indicating the number of repeated transmissions of the UL channel. Specifically, the control unit 270 may perform frequency hopping in units of the number of repeated transmissions (number of repetitions) of the specified UL channel, in other words, for each predetermined number of repetitions.

When the joint channel estimation in the gNB100 is applied, if the transmissions of the UL channels (PUSCH and PUCCH) overlap (which may be expressed as a case of collision), The control unit 270 may determine the pattern of frequency hopping (hopping pattern) using the assignable resources avoiding overlap at the time of resource allocation (which may be the repetition of the UL channel), and specifically at the timing of DCI reception.

Alternatively, if the transmissions of the UL channels (PUSCH and PUCCH) overlap, the control unit 270 may determine the hopping pattern using the assignable resources avoiding overlap at the time of the first repetition of the UL channel, and specifically at the timing of the transmission of the first repetition.

The control unit 270 may also configure the hopping pattern for the repetition of the UL channel as described above based on signaling from the network.

The control unit 270 may determine the assignment of the DMRS transmitted on the UL channel, specifically the PUSCH, based on the repeat status of the PUSCH, i.e., the number of repetitions, the repetition period, etc.

Specifically, the control unit 270 may transmit the same DMRS symbol (OFDM symbol) for each predetermined number of repetitions, the control unit 270 may configure the DMRS symbol (OFDM symbol) to be used for each predetermined number of repetitions.

As described above, the control unit 270 may allocate PUSCH across a plurality of slots, that is, it may support TBOMS. When supporting TBOMS, the control unit 270 may determine the transport block (TB) to be transmitted via PUSCH based on the DCI (control information) received by the control signal and reference signal processing unit 240.

It should be noted that crossing over a plurality of slots may mean that two or more consecutive slots are allocated to PUSCH. The unit may be a symbol or a subframe, rather than a slot.

The control unit 270 may determine the size of the transport block (TB) transmitted through the PUSCH based on the configuration information of the PUSCH in the serving cell. For example, the control unit 270 may determine the size of the TB based on the PDSCH-ServingCellConfig, which is the information element (IE) of the RRC layer. However, other information elements of the RRC layer may be used as long as they are related to the configuration information of the PUSCH, and may not necessarily be limited to the serving cells. The control unit 270 may determine the size of the TB based on the configuration information of the PUSCH of other layers other than the RRC layer.

The control unit 270 may also determine the division of the TB transmitted via the PUSCH into a plurality of code blocks (CBs) based on whether the PUSCH is allocated across a plurality of slots.

For example, the control unit 270 may divide one TB into a plurality of CBs (up to 8 CBs) as in 3GPP Releases-15 and 16. Alternatively, the control unit 270 may change the maximum number of divisions into CBs according to the number of slots (or symbols) to which the PUSCH is allocated.

The control unit 270 may also determine the modulation and encoding scheme applied to the PUSCH based on whether the PUSCH is allocated across a plurality of slots. Specifically, the control unit 270 may allocate the PUSCH across a plurality of slots, that is, in the case of TBOMS, a specific Quadrature Amplitude Modulation (QAM) may be applied as the modulation scheme, and a specific modulation and encoding scheme may be applied. A specific Coding Scheme (MCS) may be applied.

The control unit 270 may also perform rate matching for each data series transmitted in a specific time domain (For example, slots). The slot to which rate matching is applied may be only the slot to which PUSCH is actually transmitted, or it may be the resource specified in the resource allocation.

Alternatively, the control unit 270 may perform rate matching for each data series transmitted in a particular slot. Specifically, the control unit 270 may perform rate matching for each series transmitted in each slot during TBOMS transmission.

Alternatively, the control unit 270 may perform rate matching on data series transmitted using a resource to which a transport block (which may be TBOMS) is assigned. Specifically, the control unit 270 may perform rate matching on series transmitted by all resources to which TBOMS is assigned.

The functions related to DMRS transmission/reception and TBOMS described above may also be provided in gNB100. For example, gNB100 (radio signal transmission and reception unit 210) may comprise a reception unit that receives UL channels that are repeatedly transmitted within a specified period from UE200. The radio signal transmission and reception unit 210 of gNB100 may receive UL channels hopped in the frequency direction by the specified period.

Further, gNB100 (radio signal transmission and reception unit 210) may receive UL channels (For example, PUSCH) which are repeatedly transmitted, that is, repeated, from UE200 for a specified number of times. In this case, gNB100 (radio signal transmission and reception unit 210) may receive UL channels hopped in the frequency direction by the specified number of times.

The gNB100 (control unit 270) may configure a control unit to perform a UL channel assigned to a plurality of slots, e.g., a joint channel estimation of PUSCH, using a DMRS assigned to a plurality of slots.

The gNB100 (control unit 270) may also perform TBOMS processing TB via a UL channel assigned to a plurality of slots, that is, control of reception of a UL channel such as PUSCH assigned across a plurality of slots.

### (3) Operation of Radio Communication System

Next, operation of the radio communication system 10 will be described. Operation related to channel estimation of the uplink channel for the purpose of coverage performance will be described.

### (3.1) Assumptions

As described above, TBOMS may be interpreted as a technique for transmitting one transport block using a plurality of slots.

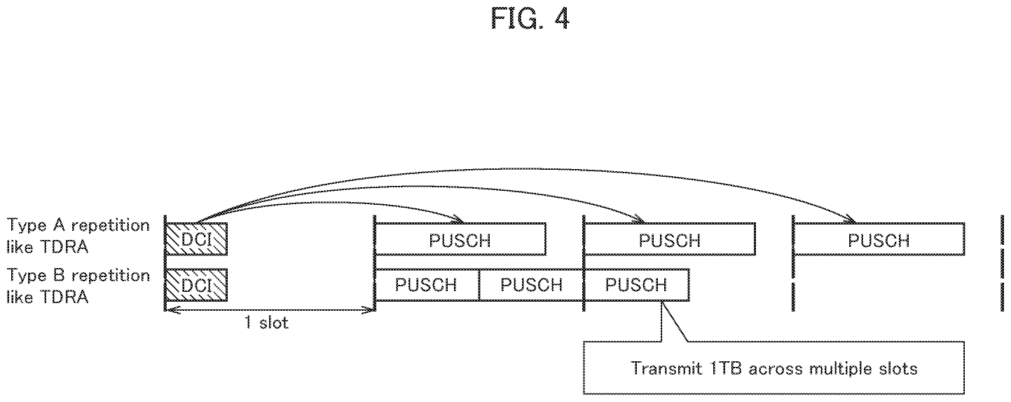

FIG. 4 shows an example of allocation of PUSCH by TBoMS. Specifically, FIG. 4 shows an example of allocation of PUSCH by TBOMS according to Type A repetition like TDRA and Type B repetition like TDRA. Types A and B have been described above. Repetition types A and B may be used.

TBoMS may have the following advantages:
The encoding rate (code rate) is reduced because resources are allocated across multiple slots.
The gain of channel coding is improved by lengthening the code sequence.
The header amount of the higher layer can be reduced compared with the case of transmitting multiple TBs.

In addition, in 3GPP Release-15 and the like, when determining the size (TBS) of TBs transmitted via PUSCH (PDSCH is the same), the number of RES (N_{RE}) is calculated first, and then the number of information bits (N_{info}) is calculated using the calculated N_{RE}. The TBS is then determined based on the calculated N_{info}. The TBS determination assumes that the PUSCH is assigned to only one slot.

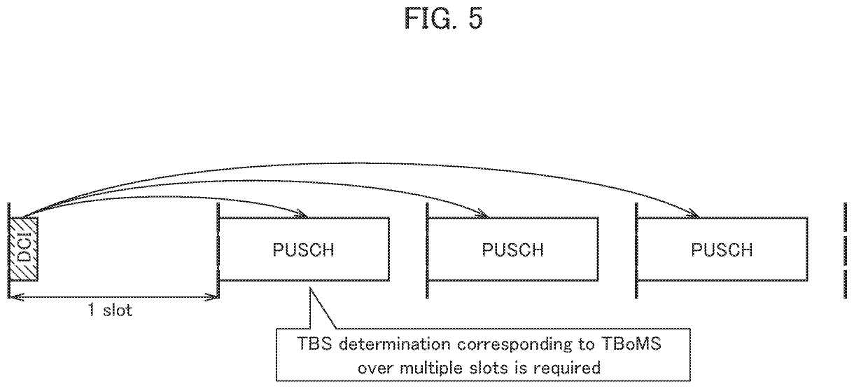

FIG. 5 is an explanatory diagram of problems in an example of assignment of the PUSCH by TBOMS (Type A repetition like TDRA). As shown in FIG. 5, in the case of TBOMS, it is necessary to determine the TBS size corresponding to the PUSCH allocated across the plurality of slots (which may be consecutive).

### (3.2) Operation Overview

The following operation examples will be described below.
(Operation example 1): Time area allocation method of PUSCH when TBOMS is applied
(Operation example 2): 1 TB transmitted in multiple slots
(Operation example 3): TBS determination method when TBoMS is applied
(Operation example 3-1): Expansion to the number of REs in multiple slots instead of 1 slot when calculating N_{RE}
(Operation example 3-2): Calculates N_{RE} based on the Start and Length Indicator Value (SLIV) of the TDRA and calculates N_{info} according to the TDRA
(Operation example 4): Method for determining the number of code blocks during TBOMS
(Operation example 5): Method for selecting the MCS table when using TBOMS
(Operation example 6): Frequency hopping when using TBOMS
(Operation example 6-1): frequency hopping (Type A repetition like TDRA)
(Operation example 6-2): frequency hopping (Type B repetition like TDRA)
(Operation example 6-3): hopping pattern when a repetition resource is dropped
(Operation example 6-4): How to receive frequency hopping-related information
(Operation example 7): Application to Msg3 PUSCH
(Operation example 7-1): Whether joint channel estimation is applicable to Msg3
(Operation example 8): Notification of UE capability

### (3.3) Operation Example 1

In this example, an operation related to the allocation of the PUSCH time region when TBOMS is applied will be described.

When the UE200 executes the TDRA of TBOMS, it may notify the network (radio base station) of the allocation method of the PUSCH time region by any of the following.
(Opt 1): Notification to consolidate multiple repetitions to be allocated into one repetition of TBOMS PUSCH
(Opt 2): Notification of the number of slots (or number of repetitions) to be allocated for PUSCH to be used to transmit one TB (1 TB) independently of the repetition (or the network may make the notification to UE200 and UE200 may operate on the notification (hereinafter the same).

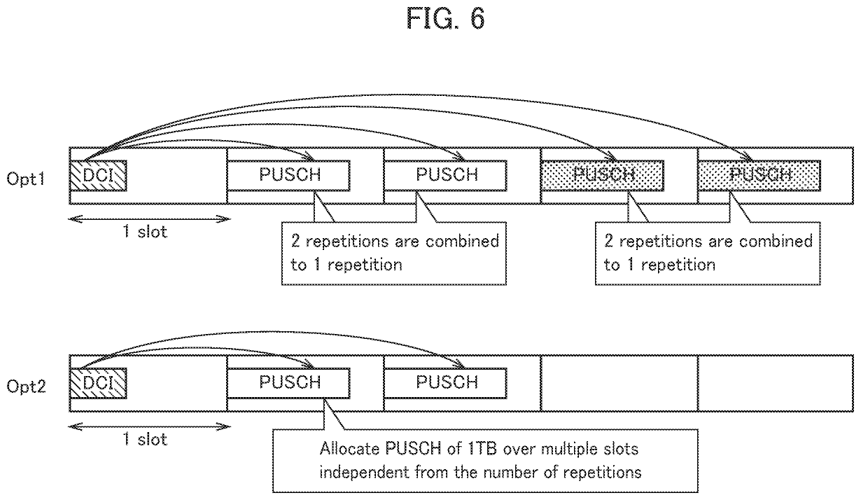

FIG. 6 shows an example of allocation of the PUSCH time region according to operation example 1 (Opt 1, 2). As shown in FIG. 6, multiple repetitions may be combined into a single repetition (Opt 1), or multiple slots may be assigned a PUSCH for 1 TB, independent of the number of repetitions.
(Opt 2-1): The number of slots (or number of repetitions) may be indicated by signaling in the higher layer.

In this case, the number of repetitions may be the actual number of repetitions to allocate, or the number of repetitions before dropping the repetition resource. For example, PUSCH-Config IE or ConfiguredGrantConfig IE of the RRC layer may be used for the signaling.
(Opt 2-2): DCI is used to indicate the number of slots (or number of repetitions)

In this case, the number of slots may be the number of slots that can actually be allocated, or the number of consecutive slots before dropping the repetition resource.
(Opt 2-2-1): explicitly notify using DCI

For example, TBOMS related information may be added as an element of the TDRA table of the RRC layer.
(Opt 2-2-2): Implicitly notify using DCI

For example, the field of DCI may be notified by linking TBoMS related information. Alternatively, TBOMS related information may be notified by linking CCE (Control Channel Element) index where the DCI for resource allocation is placed. In this case, the linking method may be notified by signaling of the higher layer or determined by a predetermined rule.

### (3.4) Operation Example 2

In this example, an operation to transmit 1 TB in multiple slots will be described. The UE200 may transmit 1 TB using multiple slots by any of the following:
(Alt 1): 1-bit series sent across multiple slots after concatenation of code blocks (CB)

Specifically, the 1-bit series may be divided, and the divided series may be sent across multiple slots using a specified resource.
(Alt 1-1): 1-bit series sent via multiple PUSCHs
(Alt 1-2): 1 PUSCH assigned to multiple slots
(Alt 2): Repeatedly transmit series after CB concatenation

Multiple series may be allocated using resources specified across multiple slots (similar to Repetition). In this case, the same series may be transmitted repeatedly or different series may be transmitted.

It should be noted that CRC attachment, CB segmentation, CRC attachment per CB, Channel coding, Rate matching, and CB concatenation may be processed in this order.
(Alt 1-1-1): An equally-divided bit series is transmitted via each PUSCH.
(Alt 1-1-2): The bit length to be transmitted is determined according to the symbol length of each PUSCH. For example, if segmentation occurs in Type B repetition like TDRA, bit series of different bit lengths may be transmitted in each repetition.

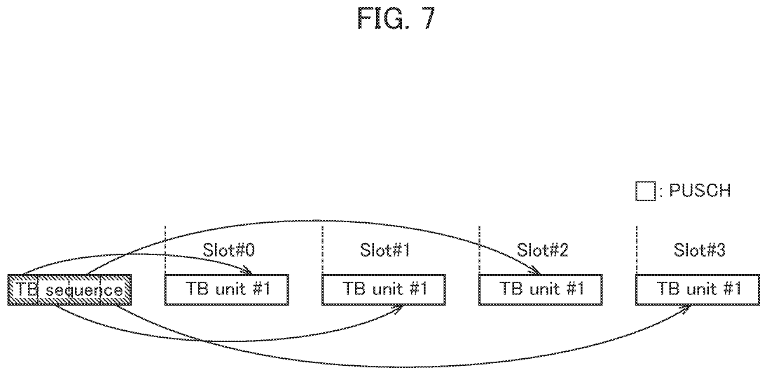

FIG. 7 shows an example of allocation of PUSCH (TB) according to operation example 2 (Alt 1-1-1).
(Alt 2-1): Conventional bit selection is used for rate matching.
(Alt 2-2): New bit selection is applied for rate matching.

For example, five or more redundancy versions (RVs) may be provided, and one may be selected during bit selection.
(Opt A): Add an RV with a different starting point in addition to an existing RV with a starting point.
(Opt B): Assign a new starting point to each RV.

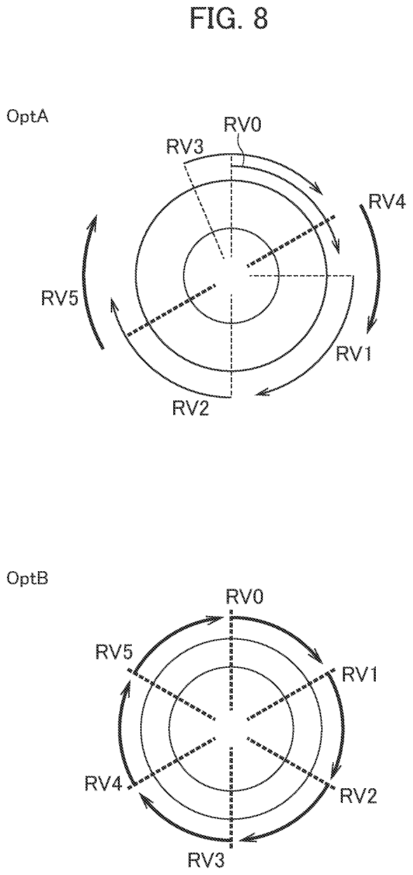

FIG. 8 shows a configuration example of redundancy version (RV) according to operation example 2 (Alt 2-2). As shown in FIG. 8, an RV (RV 0˜3) to which an existing starting point is assigned and an RV (RV 4, 5) to which a different starting point is assigned may be used (Opt A), or a new starting point may be assigned to each RV (Opt B).

### (3.5) Operation Example 3

In this example, an operation related to the determination of TBS at the time of application of TBOMS will be described. Specifically, the determination of TBS corresponding to TBs that span multiple slots will be described.
(Opt 1): When N_{RE} is calculated, it is extended to the number of REs in multiple slots instead of 1 slot (operation example 3-1).

Specifically, N_{RE} (N′_{RE}) may be calculated as follows.

$${N}_{RE}^{′} = {N}_{sc}^{RB} \cdot {N}_{symb}^{sh} - {N}_{DMRS}^{PRB} - {N}_{oh}^{PRB} \qquad [ Number 1 ]$$

Here, each variable may be changed to the number of REs across multiple slots.
(Opt 2): N_{RE} is calculated based on SLIV of TDRA, and N_{info} is calculated according to TDRA (operation example 3-2).
(Alt 1): For Type A repetition like TDRA, calculates the N_{RE} for one slot and multiplies the number of repeat transmissions during the N_{info} calculation

In this case, the number of slots may be calculated taking into account the slots to be dropped (multiplied by the number of available slots). If there is a TDD pattern, SFI (Slot Format Indication)/CI (Cancel Indication), etc., the transmitted or received TBS may change from the notified value.
(Alt 2): For Type B repetition like TDRA, calculate the N_{RE} of a single repetition and multiply the number of repeated transmissions during the N_{info} calculation
(Opt 1): Multiply the number of actual repetitions. In this case, the number of actual repetitions that have not been segmented may be multiplied.
(Opt 2): The number of nominal repetitions is multiplied.

It should be noted that the actual repetition is the final transmitted repetition, and the nominal repetition may be interpreted as the repetition reported/assigned by the gNB to the UE. For example, the actual repetition and the nominal repetition may vary depending on the following factors.

(i) If the nominal repetition is not placed in a UL symbol, the nominal repetition may be excluded.

(ii) If the nominal repetition is placed in a slot boundary, the nominal repetition may be split into two actual repetitions in the slot boundary.
(Alt 3): Add a given parameter (the parameter may be notified using DCI or higher-layer signaling)

For example, a given parameter (K) may be added when calculating the value of N_{info}: For example, K may be a value (scaling factor) that multiplies the N_{info} value by K, but is not necessarily limited to this purpose.

$${N}_{info} = {N}_{RE} \cdot R \cdot {Q}_{m} \cdot v \cdot K \qquad [ Number 2 ]$$

### (3.5.1) Operation Example 3-1

In this example, when calculating the N_{RE}, the number of REs may be extended to the number of REs in a plurality of slots instead of one slot.

In this case, the N^{PRB}ₒₕ may be calculated by any of the following:
(Opt 1): Configure the same N^{PRB}ₒₕ for all slots
   (Opt 1-1): Assign the xOverhead configured by PDSCH-ServingCellConfig to each slot
   (Opt 1-2): Configure the xOverhead configured by PDSCH-ServingCellConfig divided by the number of slots to which TBoMS is applied as N^{PRB}ₒₕ in each slot

In this case, the quotient may be adjusted to an integer by ceil or floor.
(Opt 1-3): Add a new parameter and, when using TBOMS, determine N^{PRB}ₒₕ based on the parameter
(Opt 1-4): Add a new parameter and, when using TBOMS, determine N^{PRB}ₒₕ based on the parameter and xOverhead
(Opt 2): Configure N^{PRB}ₒₕ based on the number of slot symbols to which TBOMS is applied
(Opt 2-1): Multiply xOverhead by the number of slots to which the resource is allocated (Type A repetition like TDRA)
(Opt 2-2): Multiply xOverhead by the number of repeat transmissions (Type B repetition like TDRA)
(Opt 2-2-1): Multiply the number of actual repeats.

In this case, the number of undivided actual repetitions may be multiplied.
(Opt 2-2-2): The number of nominal repetitions is multiplied.
(Opt 2-3): Calculated according to the number of symbols to be allocated with SLIV of TDRA, the number of all symbols to be allocated, and xOverhead.

For example, (xOverhead)×(number of all symbols)/(number of symbols to be allocated with SLIV of TDRA) may be calculated.

Also, in Opt 2-1, 2-2, 2-3, different parameters may be used instead of xOverhead, even configured by PDSCH-ServingCellConFIG. For example, N^{PRB}ₒₕ may be calculated based on the added parameters, xOverhead, and the number of both slot symbols. In this case, different parameters may be configured when TBOMS is applied and when it is not applied.

In addition, with respect to the calculation of Nshsymb (N^{PRB}_{DMRS}), one of the following may be applied:
(Alt 1): Change to the number of symbols (RE) of all resources to which the resource is allocated

In this case, the number of symbols (RE) may be calculated taking into account the TDD pattern, SFI, and CI.
(Alt 2): Multiplies the number of slots to which a resource can be allocated (Type A repetition like TDRA)
(Alt 3): Multiplies the number of repeat transmissions (Type B repetition like TDRA)
(Opt 1): Multiplies the number of actual repeats.

In this case, the number of undivided actual repetitions may be multiplied.
(Opt 2): The number of nominal repetitions is multiplied.

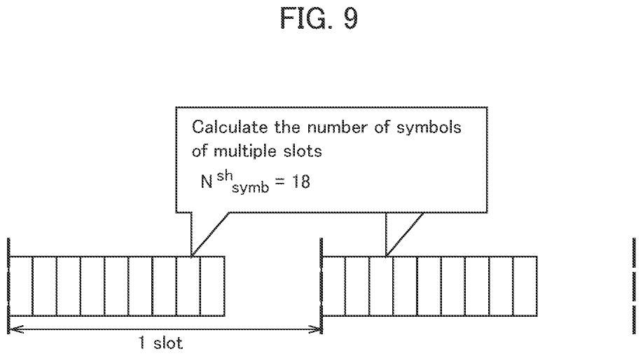

FIG. 9 shows an example of calculation of Nshsymb according to operation example 3-1 (Opt 1). As shown in FIG. 9, the number of symbols (18) of a plurality of slots may be calculated.

### (3.6) Operation Example 4

In this example, an operation related to determining the number of code blocks during TBOMS will be described. One TB for TBOMS may be divided into CBs by any of the following methods:
(Alt 1): No CB division when using TBoMS

No CB division regardless of maxCodeBlockGroupsPerTransportBlock configured by RRC
(Alt 2): As with 3GPP Releases 15 and 16, 1 TB is divided into multiple CBs (up to 8 CBs)

In this case, the maximum number of maxCodeBlockGroupsPerTransportBlocks may be increased. In addition, the maximum number of CBs when using TBOMS may be configured individually.
(Alt 3): Change the number of divisions of the maximum CB according to the number of slots (number of symbols)

In this case, the number of divisions of the maximum CB may be appropriately changed according to the number of slots (number of symbols) to which 1 TB is allocated. For example, the number of divisions to which 1 TB is allocated may be multiplied by the number of divisions of the maximum CB configured by the RRC.
(Alt 4): configure the number of CBs according to the number of repetitions when allocating resources

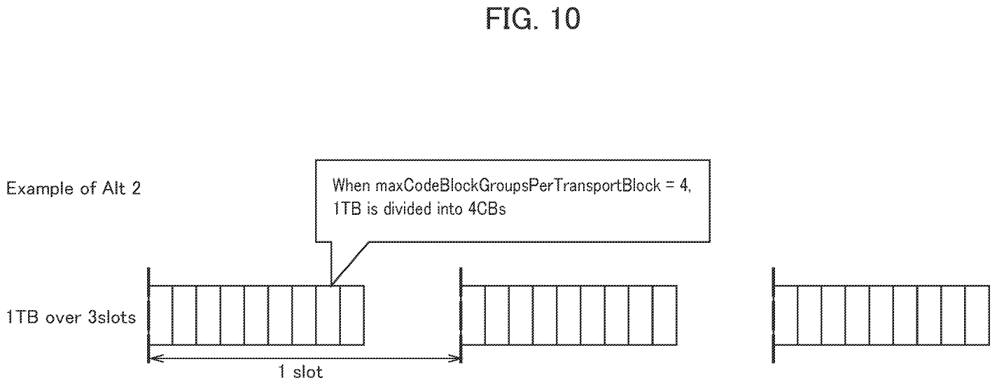

FIG. 10 shows an example of allocation of TBs according to operation example 4 (Alt 2). As shown in FIG. 10, when maxCodeBlockGroupsPerTransportBlock=4, one TB over 3 slots may be divided into 4 CBs.
(Alt 4-1): Multiplies the number of repeat placements by the maximum number of CBs
(Alt 4-2): Configures the number of repeat placements=the maximum number of CBS

For Alt 3 and Alt 4, the maximum number of CBs may be limited to 8 so that they can be accommodated by conventional DCI.

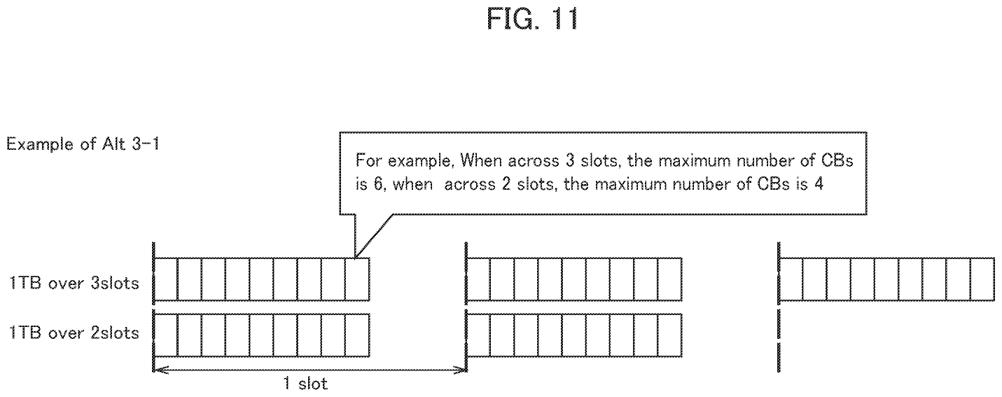

FIG. 11 shows an example of allocation of TBs according to operation example 4 (Alt 4-1). As shown in FIG. 11, when 1 TB is spread over 3 slots, the maximum number of CBs may be 6, and when spread over 2 slots, the maximum number of CBs may be 4.

### (3.7) Operation Example 5

In this example, operation related to MCS table selection when TBOMS is used will be described. Any of the following operations may be applied to the MCS table when TBOMS is used.
(Alt 1): Fixed to qam 64 low SE MCS table when TBOMS is used.

Specifically, with or without MCS-C(Cell)-RNTI, when TBOMS is used, qam 64 low SE MCS table may be fixed. This operation may be applied to Msg3. Note that Msg3 is a random access channel (RACH) procedure message, and PUSCH may be used to transmit Msg3.
(Alt 2): When TBoMS is used, a new low SE MCS table can be used.

Specifically, when TBOMS is used, a new MCS table can be used. When C-RNTI is used, one of the following MCS tables may be specified by a given rule, higher layer signaling, or DCI:
Existing MCS table
qam 64 low SE MCS table
New MCS table

Also, when using MCS-C-RNTI, one of the following MCS tables may be specified by a given rule, higher layer signaling, or DCI:
qam 64 low SE MCS table
New MCS table

Note that the MCS table may be implicitly selected according to the MCS index, TDRA, or transmission power.

### (3.8) Operation Example 6

### (3.8.1) Operation Example 6-1

This example describes the operation related to frequency hopping when TBOMS is used.

When TBoMS is applied, the UE200 may determine the hopping pattern of the UL channel from the following hopping patterns, specified by the network (radio base station) or according to a predetermined rule (configuration). The UL channel may mean either PUSCH or PUCCH (hereinafter the same). The UL channel may include a repeated PUSCH or PUCCH.

Specifically, the UE200 may determine one of the following hopping patterns when Type A repetition like TDRA is applied or PUCCH is used.
(Opt 1): frequency hopping per slot
(Opt 2): frequency hopping within a slot
(Opt 3): frequency hopping only once within a repetition transmission
   (Opt 3-1): unique hop duration calculated based on number of repetition transmissions

In this case, frequency hopping may not be performed based on the number of repetition transmissions in the UL channel. The number of repetitions may be the number of repetitions actually allocated, or the number of repetitions before dropping the repetition resource. The dropping of the repetition resource may be interpreted as a resource (time resource and/or frequency resource) that cannot be allocated due to the collision (overlapping allocation) of the repetition resource with a resource of another UL channel.

For example, the hop duration may be determined by first hopping duration=floor (number of repetitions/2) or ceil (number of repetitions/2).
(Opt 3-2): Notify slot location for frequency hopping

For example, the UE200 may notify the network that duration per hop=X number of slots (X number of repetitions), transmit X repetitions (Transmitting X number of repetitions), and then frequency hop. Alternatively, the network may transmit the notification to the UE200, and the UE200 may operate based on the notification.

The number of slots may be the number of slots actually allocated by the Repetition, or the number of slots before the Repetition resource is dropped.

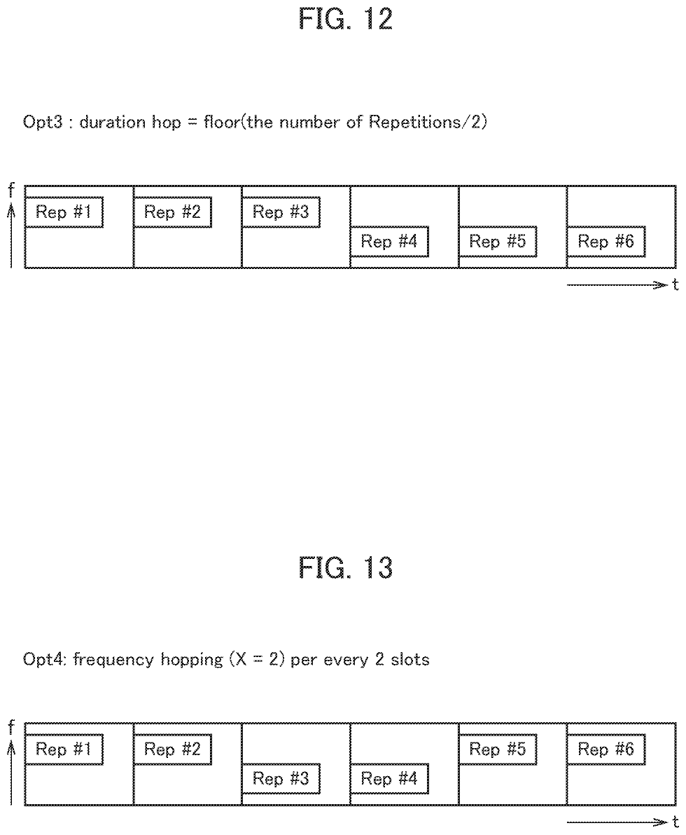

FIG. 12 shows an example of Repetition of the UL channel according to the operation example 6 (Opt 3). As shown in FIG. 12, the hop period may be determined as floor (Repetition (Rep) number (6)/2)=3. In FIG. 12, each frame in the time (t) direction may be interpreted to correspond to a slot (However, symbols may be used.).

The hop duration may be expressed in terms such as duration hop, hopping duration, and duration per hop, and may be indicated by the time length or the number of repetitions.
(Opt 4): frequency hopping for each X slot
   (Opt 4-1): duration per hop is reported from the network

For example, duration per hop=X number of slots and frequency hopping may be reported for each X slot.
(Opt 4-2): Determine the hopping pattern based on the number of slots (or symbols) to which the joint channel estimation is applied

For example, if the time window size is 3 slots, frequency hopping may occur every 3 slots. The time window size may be in units of slots or other time regions such as symbols (hereinafter the same).
(Opt 4-3): Determine duration per hop based on the number of repeated transmissions
(Opt 4-4): Determine hopping pattern based on the number of repeated transmissions and the number of slots (or symbols) to which joint channel estimation is applied

FIG. 13 shows an example of Repetition of the UL channel according to operation example 6-1 (Opt 4). As shown in FIG. 13, frequency hopping (X=2) may be performed every 2 slots.

### (3.8.2) Operation Example 6-2

This operation example describes the operation related to frequency hopping (Type B repetition like TDRA) when TBOMS is applied.

The UE200 may determine the hopping pattern of the UL channel according to a network (radio base station) or a predetermined rule from the following hopping pattern.

Specifically, the UE200 may determine any of the following hopping patterns when the Type B repetition like TDRA is applied.
(Opt 1): frequency hopping per slot
(Opt 2): frequency hopping per repetition
(Opt 3): frequency hopping only once in a repetition transmission
(Opt 4): frequency hopping per X slots

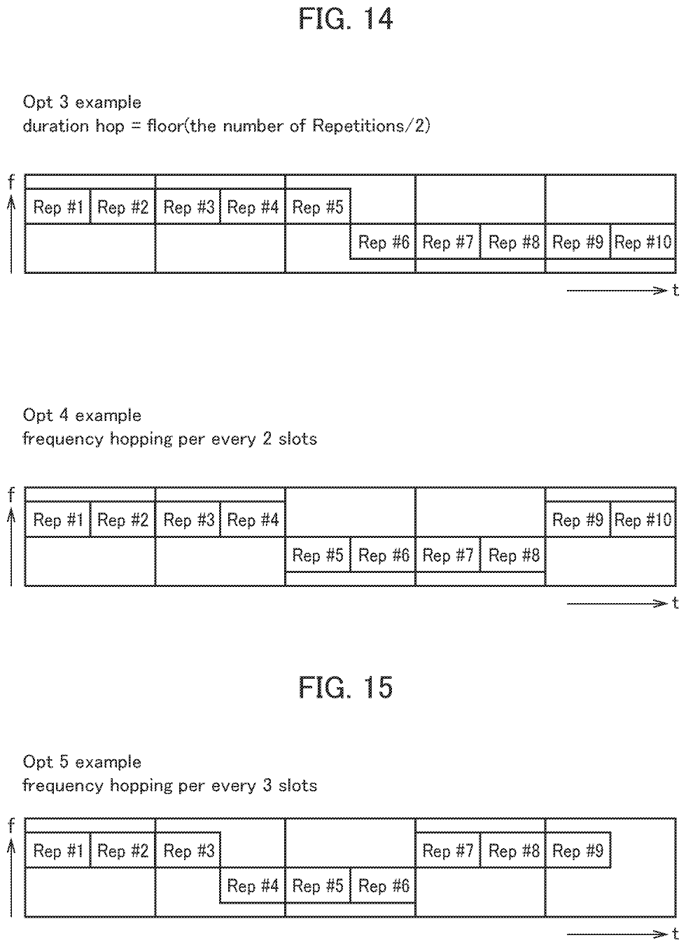

FIG. 14 shows an example of Repetition of the UL channel according to operation example 6-2 (Opt 3, 4). Specifically, the upper side of FIG. 14 shows an example of Repetition of the UL channel according to Opt 3, and the lower side of FIG. 14 shows an example of Repetition of the UL channel according to Opt 4.

As shown in FIG. 14, the hop period may be determined as floor (number of Repetition (10)/2)=5, or frequency hopping (X=2) may be performed every 2 slots. Further, as shown in FIG. 14, in the case of a Type B repetition like TDRA, a plurality of Repetitions (Reps) may be repeated in a slot, and a plurality of Repetitions may be assigned in the same slot.
(Opt 5): Frequency hopping for each X Repetition
   (Opt 5-1): Duration per hop is reported from the network

For example, UE200 may report duration per hop=X number of repetitions and frequency hopping per X repetitions.
(Opt 5-2): Determine the hopping pattern based on the number of slots (or symbols) to which the joint channel estimation is applied

For example, if the time window size is 3 slots, frequency hopping may occur every 3 slots. The time window size may be a time region to which joint channel estimation is applicable, in units of slots, or in units of other time regions, such as symbols.

FIG. 15 shows an example of Repetition of the UL channel according to operation example 6-2 (Opt 5). As shown in FIG. 15, frequency hopping may be performed every 3 slots. Further, as shown in FIG. 15, the timing of hopping may be in the slot (intermediate) rather than at the slot boundary.

### (3.8.3) Operation Example 6-3

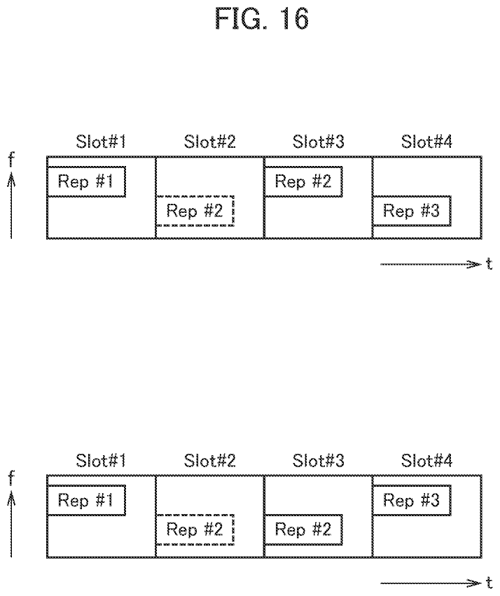

This operation example describes the operation related to the hopping pattern when the Repetition resource is dropped when TBoMS is applied. FIG. 16 shows an example of Repetition of the UL channel according to operation example 6-3 (Alt 1, 2).

The UE200 may apply any of the following hopping patterns when joint channel estimation is applied (on the radio base station side) and the Repetition resources of the UL channel (For example, PUSCH) collide (may be called overlaps) with different resources (For example, resources for PUCCH).
(Alt 1): Hopping pattern is applied without considering resource collisions

In this case, the hopping pattern may be applied on a per-slot basis without considering when resources are dropped. For example, a similar hopping pattern may be maintained when a second Repetition resource is dropped (Top reference in FIG. 16, showing the dropped Repetition resource as a dotted line).
(Alt 2): Apply hopping pattern based on resources actually sent

In this case, the hopping pattern may be applied based on the resources used to transmit each Repetition. For example, if the second Repetition resource is dropped, the hopping pattern may be applied except for the dropped resource (The lower reference in FIG. 10, the dropped Repetition resource (dotted box) is removed, so that the resources in the frequency direction after slot #3 are different from Alt 1).

When the hopping pattern is applied as described later, or when the number of repeat transmissions based on the number of resources that can be allocated is specified, Alt 1 and 2 may be configured separately.

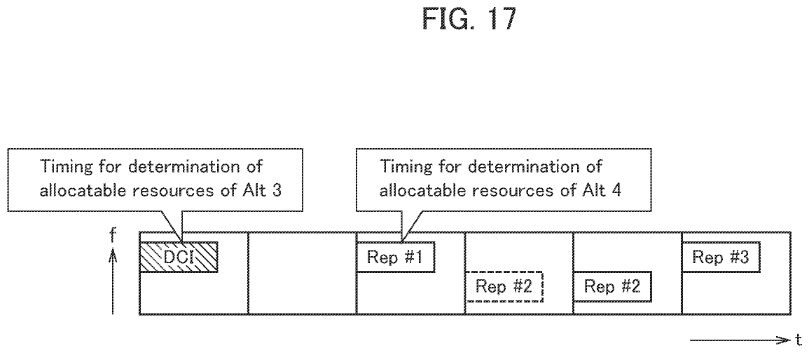

FIG. 17 shows an example of Repetition of the UL channel according to operation example 6-3 (Alt 3, 4).
(Alt 3): When resources are allocated, a hopping pattern is applied based on the available Repetition resources.

In this case, the available resources may be determined according to the collision reason. For example, the symbols of TDD pattern, SS/PBCH block (Synchronization Signal/Physical Broadcast Channel blocks) may be considered, but the collision with the repeated transmission of SFI (Slot Format Indication)/CI (Control Information)/PUCCH may not be considered. Alternatively, a drop of a Repetition resource known to the radio base station (gNB100) may be considered, but a drop that the radio base station cannot determine may not be considered.
(Alt 4): When the first Repetition is sent, a hopping pattern is applied to the available Repetition resources.

In this case, the available resources may be determined according to the time collision reason. As in Alt 3, for example, symbols of TDD pattern, SS/PBCH block may be considered, but collisions with repeated SFI/CI/PUCCH transmissions may not be considered. Alternatively, drops of Repetition resources for which the radio base station is known may be considered, but drops for which the radio base station cannot determine may not be considered.

### (3.8.4) Operation Example 6-4

In this example, the UE200 may receive frequency hopping-related information by any of the following methods:
(Opt 1): DCI
(Opt 1-1): Explicit frequency hopping-related information by DCI fields

In this case, the association (correspondence) between frequency hopping-related information and DCI fields may be based on higher layer signaling or according to pre-specified rules (configurations).
(Opt 1-2): In the higher layer, an information element of frequency hopping-related information is added to the TDRA table and determined by DCI.
(Opt 1-3): Implicit frequency hopping-related information by a field of DCI.

For example, frequency hopping-related information may be associated with a field of DCI. Alternatively, frequency hopping-related information may be associated with a control channel element (CCE) index where a DCI for resource allocation is located.
(Opt 2): Higher layer signal

For example, the hopping pattern may be selected based on the frequency hopping-related information received in the RRC.
(Opt 3): The hopping pattern is determined based on a predetermined rule.

For example, in the case of channel estimation using multiple slots, any option of hopping pattern may be specified.

In addition, the UE200 may configure the hopping pattern by any of the following methods.
Setting the number of slots to which joint channel estimation is applied and the hop duration parameter separately or in common
Setting the Type A like repetition TDRA and Type B like repetition TDRA parameters separately or in common
Setting the Type B like repetition TDRA hop duration and number of slots and number of repetitions parameters separately or in common

### (3.9) Operation Example 7

In this operation example, an operation related to the application of TBOMS to Msg3 PUSCH will be described.

The UE200 may receive relevant information for TBOMS for Msg3 initial transmission based on any of the following methods or combinations: In this case, the settings for TBOMS may be different depending on the frequency (band) used by the UE.
Notification to UE200 by higher layer signaling

For example, PUSCH-ConfigCommon IE (Information Element) or RACH-ConfigCommon IE specified in the RRC layer may be used. Msg3 is a random access channel (RACH) procedure message, and PUSCH may be used to transmit Msg3.

Msg1 may also be transmitted via PRACH (Physical Random Access Channel). Msg1 may be referred to as PRACH Preamble. Msg2 may be transmitted via PDSCH. Msg2 may be referred to as a Random Access Response (RAR). Msg3 may be referred to as an RRC Connection Request. Msg4 may be referred to as an RRC Connection Setup.

### Notification to UE200 Through Msg2 RAR

Either of the following methods may be applied:
(Alt 1): Notify the enhanced UE by transmitting a RAR with a different MAC configuration than the normal UE

An enhanced UE may mean a UE that supports TBOMS.

### (Alt 2): Notification Using UL Grant TDRA

For example, an information element on channel estimation across multiple slots may be added to the TDRA table configured in RRC, and the information may be selected by DCI.

### (Alt 3): Implicitly Notify Using Information of UL Grant

For example, it may be tied to TPC (Transmit Power Control) command or MCS (Modulation and Coding Scheme). In this case, the tying method may be configured by a predetermined rule or network (radio base station).

### (Alt 4): Notification Using Reserved Bits

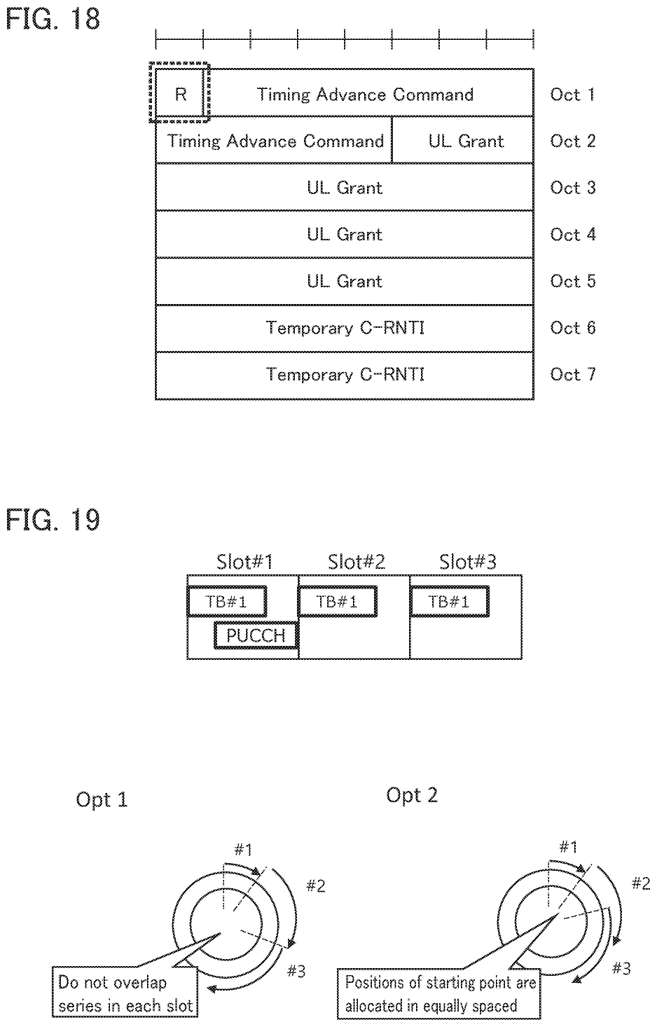

FIG. 18 shows a configuration example of MAC RAR according to operation example 7. As shown in FIG. 18, the reserved bit (R) included in MAC RAR may be used for the above-mentioned notification. For example, the reserved bit may be used to notify only whether or not TBoMS is used.

In addition, TBoMS-related information may be added to the PUSCH-ConfigCommon information element TDRA table for notification by higher-layer signaling.

Alternatively, for notification through DCI format 0_0 with CRC scrambled by TC-RNTI (Temporary C (Cell)-RNTI), one of the following may apply:
(Alt 1): TBOMS related information is implicitly notified according to the CCE index where the DCI is located
(Alt 2): TBOMS related information is notified using reserved bits of HARQ process number and New data indicator
(Alt 3): Implicitly notified by information communicated by DCI

For example, TDRA, TPC command or MCS may be associated with relevant information. In this case, the association method may be configured by a predetermined rule or network (radio base station).

Alternatively, RNTI for DCI with CRC scrambled by Enhanced UE may be used. RNTI for Enhanced UE may be assigned by RAR. TBOMS related information may also be notified by DCI for Enhanced UE.

Further, the UE200 may report (notify) to the network (radio base station) whether or not TBoMS is applied at the time of Msg3 transmission based on any of the following methods.
(Opt 1): Report together with the applicability (or request) of repeated Msg3 transmission In the case of repeated Msg3 transmission, the applicability of TBOMS may be included.
   (Opt 2): Report the applicability of repeated Msg3 transmission (or request) independently.
   (Opt 2-1): Assign different initial bandwidth depending on applicability (or request).
   (Opt 2-2): Use different RACH preamble depending on applicability (or request).
   (Opt 2-3): Use different RACH occasion depending on applicability (or request).
   (Opt 2-4): Use specific Orthogonal Cover Code (OCC) pattern in Msg1 repeatedly transmitted depending on applicability (or request).

### (3.10) Operation Example 8

In this example, an operation related to rate matching at the time of TBOMS transmission will be described. Specifically, rate matching may be applied to each series transmitted in each slot.

The UE200 may perform rate matching for each series transmitted in each slot during TBOMS transmission. In this case, the slot may be only the slot where the PUSCH is actually transmitted, or it may be a resource specified by resource allocation.

FIG. 19 shows a configuration example of slot allocation and redundancy version (RV) according to operation example 8. FIG. 19 shows an example of UCI multiplexing in Slot 1 to shorten the sequence of bit selection.

The UE200 may determine the starting point of the bit selection of the series transmitted in each slot in one of the following ways:
(Opt 1): determine the starting point of the bit selection so that it is a continuous series. For example, the first slot may be determined according to the RV. For subsequent slots, the starting point may be the last bit (or the bit following the last bit) of the circular buffer extracted by the bit selection in the previous slot.
(Opt 2): Starting points are determined so that the starting points of the bit selection are equally spaced in each slot.

For example, the starting point of the first slot may be determined according to the RV, and the starting point of the other slot may deviate from the starting point of the previous slot by the series length extracted by the bit selection of the specific slot. In this case, the specific slot may be the series whose series length extracted by the first slot or the bit selection is the shortest.
(Opt 3): bit selection based on the RV corresponding to each slot

At this time, a starting point different from 3GPP Releases 15 and 16 may be applied. For example, the mapping between each RV and the starting point may be changed only when applying it to the TBoMS. As an example of changing the mapping between each RV and the starting point, the starting point may be determined in the same manner as in Opt 1 and 2. At this time, as described above, five or more RVs may be applied (See Opt A, B in FIG. 8).

### (3.11) Operation Example 9

In this operation example, as in the operation example 8, an operation related to rate matching at the time of TBOMS transmission will be described. Specifically, rate matching may be applied to each series transmitted in a particular slot (which may be a single or a plurality), the X slot.

The UE200 may perform rate matching for each series transmitted in the X slot during TBOMS transmission. In this case, the slot may be only the slot where the PUSCH is actually transmitted, or it may be a resource specified by resource allocation.

“X” may be determined based on a combination of a predetermined rule/RRC parameter/predetermined rule and RRC parameter. For example, X may be the number of consecutive UL slots based on the TDD pattern.
(Operation example 9-1): bit selection
   (Opt 1): bit selection starting point is determined so that the sequence is continuous

Every slot in Opt 1 of operation example 8 may be changed every X slot and applied.
(Opt 2): Determine the starting point so that the starting point of the bit selection is evenly spaced in each slot

Each slot in Opt 2 of operation example 8 may be changed for each X slot and applied.
(Opt 3): In determining the starting point based on the RV corresponding to each X slot, a starting point different from 3GPP Releases 15 and 16 may be applied. For example, the mapping between each RV and the starting point may be changed only when applying it to the TBoMS. In this case, as described above, five or more RVs may be applied (See Opt A, B in FIG. 8).

### (Operation Example 9-2): Bit Interleaving

The UE200 may be applied for each series transmitted in each slot when performing bit interleaving.

### (3.12) Operation Example 10

In this operation example, as in the operation example 8, an operation related to rate matching at the time of TBoMS transmission will be described. Specifically, in this operation example, rate matching may be applied to all series transmitted by TBOMS.

When transmitted by TBOMS, the UE200 may perform rate matching on series transmitted by all resources to which TBoMS is assigned. In this case, the slot may be only the slot to which PUSCH is actually transmitted, or it may be a resource specified by resource allocation.

The UE200 may apply rate matching to each series transmitted in each slot when performing bit interleaving.

Alternatively, the UE200 may apply rate matching to each series transmitted in the X slot when performing bit interleaving.

“X” may be determined based on a combination of a predetermined rule/RRC parameter/predetermined rule and RRC parameter. For example, X may be the number of consecutive UL slots based on the TDD pattern.

### (3.13) Operation Example 11

In this example, an operation related to notification of UE capability will be described.

The UE200 may report the following information regarding the TBOMS to the network as UE Capability Information:
Whether repeated transmission of the TBOMS PUSCH is applicable
Whether each RV extension is applicable when TBOMS is applied
Whether the new low SE MCS table is applicable when TBOMS is applied
Whether each frequency hopping pattern is applicable when TBOMS is applied
Whether TBoMS is applicable to Msg3 PUSCH In addition, the UE200 may report the following information regarding rate matching in TBOMS to the network as UE Capability Information:
Applicability of option (Opt) for each operation example (operation example 8˜10)

The applicability of each operation example may be reported individually, or the applicability of multiple operations may be reported collectively.
Maximum number of slots in the operation examples 8 and 9
Maximum number of X slots in the operation examples 9 and 10

The UE200 may also report the corresponding (supported) frequency (FR or band) in one of the following ways:
Whether all frequencies can be supported at the same time (as a mobile station)
Whether each frequency can be supported
Whether each FR1/FR2 can be supported
Whether each SCS can be supported

Further, the UE200 may report the corresponding duplex method by any of the following methods.
Whether the UE can support
Whether each duplex (TDD/FDD) can support

### (4) Operational Effects

According to the above-described embodiment, the following effects can be obtained. Specifically, according to the UE200 (and gNB100) according to the above-described operation example 1˜8, a TBOMS for processing a transport block (TB) via a physical uplink shared channel (PUSCH) allocated to a plurality of slots can be more efficiently realized.

In particular, according to the above-described operation example, appropriate placement of a PUSCH considering the TBOMS, TBS determination, code block determination, MCS table selection, frequency hopping, transmission of Msg3, transmission of UE CapabilityInformation, etc. can be realized.

### (5) Other Embodiments

Although the embodiments have been described above, they are not limited to the description of the embodiments, and it is obvious to those skilled in the art that various modifications and improvements can be made.

For example, in the embodiment described above, the term transport block (TB) was used, but as will be described later, it is a block of predetermined data and may be replaced by another synonymous term such as, for example, a data packet.

In the embodiment described above, a demodulation reference signal (DMRS) used for channel estimation of PUSCH (or PUCCH) has been described, but the reference signal used for channel estimation of a physical channel such as PUSCH (or PUCCH) may be any other reference signal.

In the description described above, setting (configure), activating (activate), updating (update), indicating (indicate), enabling (enable), specifying (specify), and selecting (select) may be replaced with each other. Similarly, link, associate, correspond, and map may be replaced with each other, and allocate, assign, monitor, and map may be replaced with each other.

In addition, specific, dedicated, UE-specific, and UE-specific may be replaced with each other. Similarly, common, shared, group-common, UE-common, and UE-shared may be replaced with each other.

Further, the block configuration diagram (FIG. 3) used for the description of the above-described embodiment shows blocks of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (configuration part) that functions transmission is called a transmission unit (transmitting unit) or a transmitter. As described above, the method of realization of both is not particularly limited.

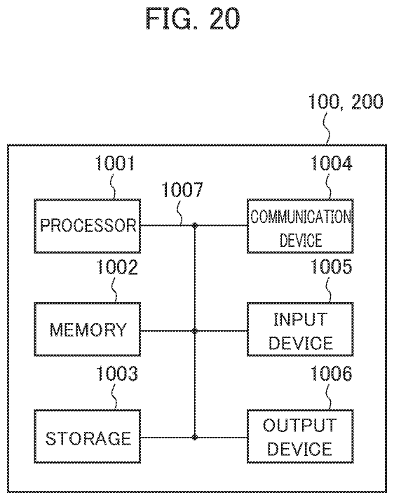

In addition, the above-mentioned gNB100 and UE200 (the device) may function as a computer for processing the radio communication method of the present disclosure. FIG. 20 is a diagram showing an example of a hardware configuration of the device. As shown in FIG. 20, the device may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 3) is implemented by any hardware element or combination of hardware elements of the computer device.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001, for example, operates an operating system to control the entire computer. The processor 1001 may be configured with a central processing unit (CPU), including interfaces to peripheral devices, controls, computing devices, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), or the like. The memory 1002 may store a program (program code), a software module, or the like capable of executing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

In addition, the device may be configured to include hardware such as a microprocessor, a digital signal processor (DSP), an application specific integrated circuit (ASIC), a programmable logic device (PLD), a field programmable gate array (FPGA), or the like, which may provide some or all of each functional block. For example, the processor 1001 may be implemented by using at least one of these hardware.

The notification of information is not limited to the aspects/embodiments described in the present disclosure and may be carried out using other methods. For example, the notification of information may be performed by physical layer signaling (e.g., Downlink Control Information (DCI), Uplink Control Information (UCI), higher layer signaling (e.g., RRC signaling, Medium Access Control (MAC) signaling, Notification Information (Master Information Block (MIB), System Information Block (SIB)), other signals or combinations thereof. RRC signaling may also be referred to as RRC messages, e.g., RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing steps, sequences, flowcharts, etc., of each of the embodiments/embodiments described in the present disclosure may be reordered as long as there is no conflict. For example, the method described in the present disclosure presents elements of various steps using an exemplary sequence and is not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from a higher layer (or lower layer) to a lower layer (or higher layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value). Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, planes, etc.), an unmanned mobile (For example, drones, self-driving cars,), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal, hereinafter the s same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc.). In this case, the mobile station may have the function of the base station. Further, words such as “up” and “down” may be replaced with words corresponding to communication between terminals (For example, “side”). For example, terms an uplink channel, a downlink channel, or the like may be read as a side channel.

Similarly, the mobile station in the present disclosure may be replaced with a base s station. In this case, the base station may have the function of the mobile station.

A radio frame may be composed of one or more frames in the time domain.

Each frame or frames in the time domain may be referred to as a subframe. A subframe may be further configured by one or more slots in the time do. main.

The subframe may have a fixed time length (e.g., 1 ms) that does not depend on the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in units of time greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframes and TTI may be a subframe in an existing LTE (1 ms), a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain.

The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to transmit and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” and “decision” may include regarding some action as “judgment” and “decision.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.”

Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 NG-RAN
100 gNB
200 UE
210 radio signal transmission and reception unit
220 amplifier unit
230 modulation and demodulation unit
240 control signal and reference signal processing
unit
250 encoding/decoding unit
260 data transmission and reception unit
270 control unit
1001 processor
1002 memory
1003 storage
1004 communication device
1005 input device
1006 output device
1007 bus

1. A terminal comprising:
a control unit that allocates a physical uplink shared channel across multiple slots; and
a transmission unit that transmits data series via the physical uplink shared channel, wherein
the control unit performs rate matching for each of the data series transmitted in a specific time region.

2. The terminal according to claim 1, wherein the control unit performs rate matching for each of the data series transmitted in a specific slot.

3. The terminal according to claim 1, wherein the control unit performs rate matching for the data series transmitted using a resource to which a transport block is allocated.

4. A radio communication method comprising the steps of:
allocating a physical uplink shared channel across multiple slots; and
transmitting the data series via the physical uplink shared channel, wherein
In the allocation step, rate matching is performed for each of the data series transmitted in a specific time region.
